(19) United States
(12) Patent Application Publication
(10) Pub. No.: US 2012/0169264 A1
(43) Pub. Date: Jul. 5, 2012

(54) METHOD AND APPARATUS FOR COMMUTATING A BRUSHLESS DC MOTOR

(75) Inventors: John K. Rote, Allen, TX (US); Seil Oh, Dallas, TX (US)

(73) Assignee: Texas Instruments Incorporated, Dallas, TX (US)

(21) Appl. No.: 12/985,090

(22) Filed: Jan. 5, 2011

(51) Int. Cl. H02P 6/18

(52) U.S. Cl. 318/400.32

(57) ABSTRACT

Traditionally, controllers for brushless, sensorless direct current (DC) motors (in, for example, Hard Disk Drive applications) would use one of the phases of the DC motor to measure a back electromotive force (back-EMF) voltage. This measurement would generally cause a discontinuity in the current waveform for a motor operating at a generally constant rotational speed (i.e., at “run speed”), which would result in poor acoustic performance (i.e., audible hum). Here, however, an integrated circuit (IC) is provided that uses coil current and applied voltage measurements to substantially maintain a predetermined phase difference between the phase of the applied voltage and back-EMF voltage, eliminating the need for a back-EMF voltage measurement and improving the acoustic performance.

### TECHNICAL FIELD

The invention relates generally to motor control and, more particularly, to commutating a sensorless, brushless direct current (DC) motor.

### BACKGROUND

In a multi-phase motor system, torque induced by the motor is the sum of the individual torque from each phase. The individual torque is product of coil current and back electromotive voltage or back-EMF voltage and can be expressed as follows:

N∝V_{EMF}I, (1)

where N is torque, I is current, and V_{EMF} is the back-EMF voltage. High quality three-phase brushless DC motors (for example) generate a sinusoidal back-EMF voltage which is function of velocity and rotor position. Each terminal of three phases generates the sinusoidal wave separated by 120 degrees, as shown below:

V_{EMFA}(t)=sin(wt) (2)

I_{A}(t)=sin(wt) (3)

V_{EMFB}(t)=sin(wt+120°) (4)

I_{B}(t)=sin(wt+120°) (5)

V_{EMFC}(t)=sin(wt−120°) (6)

I_{C}(t)=sin(wt−120°) (7)

In advanced motor control systems, such as Hard Disk Drives (HDDs), the controller also applies the sinusoidal voltage across the motor resulting sinusoidal current in each of the phases to deliver a generally constant torque into the motor. Torque induced by each phase is as follows:

$$\begin{matrix}{N}_{A} ( t ) ∝ {V}_{EMFA} ( t ) \cdot {I}_{A} ( t ) = {sin}^{2} ( ω t ) = \frac{1}{2} ( 1 - cos ( 2 ω t ) ) & ( 8 ) \\ \begin{matrix}{N}_{B} ( t ) ∝ {V}_{EMFB} ( t ) \cdot {I}_{B} ( t ) = {sin}^{2} ( ω t + 120 ° ) \\ = \frac{1}{2} ( 1 - cos ( 2 ω t + 240 ° ) ) \\ = \frac{1}{2} ( 1 - cos ( 2 ω t - 120 ° ) )\end{matrix} & ( 9 ) \\ \begin{matrix}{N}_{C} ( t ) ∝ {V}_{EMFC} ( t ) \cdot {I}_{C} ( t ) = {sin}^{2} ( ω t - 120 ° ) \\ = \frac{1}{2} ( 1 - cos ( 2 ω t - 240 ° ) ) \\ = \frac{1}{2} ( 1 - cos ( 2 ω t + 120 ° ) )\end{matrix} & ( 10 )\end{matrix}$$

which results in the total torque being:

$$N ( t ) = {N}_{A} ( t ) + {N}_{B} ( t ) + {N}_{B} ( t ) ∝ \frac{1}{2} ( 1 - cos ( 2 ω t ) ) + \frac{1}{2} ( 1 - cos ( 2 ω t - 120 ° ) ) + \frac{1}{2} ( 1 - cos ( 2 ω t + 120 ° ) ) = \frac{1}{2} ( 3 - cos ( 2 ω t ) - 2 cos ( 2 ω t ) cos ( 120 ° ) ) = \frac{1}{2} ( 3 - cos ( 2 ω t ) - 2 cos ( 2 ω t ) ( - \frac{1}{2} ) ) = \frac{3}{2} \qquad ( 11 )$$

Thus, as shown, the total torque induce by the motor is generally constant.

For sensorless, brushless DC motors, conventional controllers often use the back-EMF voltage generated by the motor to commute the motor when the motor is operating at a generally constant rotational speed. For example, in a three-phase DC motor, two of the phases are engaged while the third phase is in a high impedance state. Commutation logic within the controller will use the third phase to measure the time for a zero-crossing of the back-EMF voltage, but, in this window (where the back-EMF voltage is measured), the controller introduces a discontinuity in the current waveform (which, in turn, introduces a disturbance in the torque applied to the rotor). This disturbance in the torque (which, as shown above, should be generally constant) can then degrade the acoustic performance, creating an audible hum.

Turning to FIG. 1, an example of the performance of a system that uses a conventional controller (which measures back-EMF in a window) can be seen. As shown, the zero-crossings for the back-EMF voltage can be seen as pulses, but the back-EMF voltage is not shown. The window for the back-EMF voltage measurement occurs near each zero-crossing, allowing the determination of the next zero-crossing. This window, therefore, creates a discontinuity (as shown) in the current waveform, which creates an acceleration and deceleration in the rotor of the DC motor and an audible hum.

Therefore, there is a need for a method and/or apparatus to control a sensorless, brushless DC motor with improved acoustical performance.

Some examples of conventional methods and/or systems are: U.S. Pat. No. 6,124,689; U.S. Pat. No. 7,412,339; U.S. Pat. No. 7,834,565; U.S. Patent Pre-Grant Publ. No. 2007/0018598; U.S. Patent Pre-Grant Publ. No. 2010/0270956; Liu et al., “Commutation-Torque-Ripple Minimization in Direct-Torque-Controlled PM Brushless DC Drives,” IEEE Trans. on Industry Applications, Vol. 43, No. 4, July/August 2007, pp. 1012-1021; Soh et al., “Sensorless Optimal Sinusoidal Brushless Direct Current for Hard Disk Drives,” J. of Applied Physics, Vol. 105, No. 7, April 2009; and Ahfock et al., “Sensorless Commutation of Printed circuit Brushless Direct Current Motors,” IET Electric Power Applications, Vol. 4, No. 6, pp. 397-406.

### SUMMARY

A preferred embodiment of the present invention, accordingly, provides a method. The method comprises sensing a phase of a coil current of a brushless direct current (DC) motor; and adjusting a phase and frequency of an applied voltage for the brushless DC motor based at least in part on the phase of the coil current to substantially maintain a predetermined phase difference between the phase of the applied voltage and a phase of a back electromotive force (back-EMF) voltage.

In accordance with a preferred embodiment of the present invention, the method further comprises generating a commutation clock signal.

In accordance with a preferred embodiment of the present invention, the method further comprises generating the applied voltage to drive the brushless DC motor with commutation clock signal.

In accordance with a preferred embodiment of the present invention, the step of sensing further comprises: sensing the coil current; digitizing the coil current; and determining the phase of the coil current from the digitized coil current.

In accordance with a preferred embodiment of the present invention, the step of adjusting is performed by a phase lock loop (PLL).

In accordance with a preferred embodiment of the present invention, the step of adjusting further comprises: calculating an adjustment for the phase and frequency of the applied voltage based at least in part on the digitized coil current with a digital signal processor (DSP); and applying the adjustment to the commutation clock signal.

In accordance with a preferred embodiment of the present invention, an apparatus is provided. The apparatus comprises a drive circuit that drives a brushless DC motor; a sense circuit that is coupled to the drive circuit so as to measure a coil current for the brushless DC motor; and a control circuit that is coupled to the sense circuit and the drive circuit, wherein the control circuit determines a phase of the coil current, and wherein the control circuit adjusts a phase and frequency of an applied voltage for the brushless DC motor to substantially maintain a predetermined phase difference between the phase of the applied voltage and a phase of a back-EMF voltage.

In accordance with a preferred embodiment of the present invention, the sense circuit further comprises a sense FET.

In accordance with a preferred embodiment of the present invention, the control circuit further comprises: an analog-to-digital converter (ADC) that is coupled to the sense circuit so as to generate a digitized coil current; a DSP having a memory with a computer program embodied thereon, wherein the DSP is coupled to the ADC, and wherein the DSP calculates an adjustment for the phase and frequency of the applied voltage based at least in part on the digitized coil current; and a controller that is coupled between the DSP and drive circuit, wherein the controller generates a commutation clock signal for the drive circuit, and wherein the controller applies the adjustment to the commutation clock signal, and wherein the drive circuit generates the applied voltage based at least in part on the commutation clock signal.

In accordance with a preferred embodiment of the present invention, the drive circuit further comprises: a pre-driver that is coupled to the controller so as to receive the commutation clock signal; and a driver that is coupled to the pre-driver and the sense circuit.

In accordance with a preferred embodiment of the present invention, the controller further comprises a PLL.

In accordance with a preferred embodiment of the present invention, the apparatus further comprises the DC brushless motor, which is coupled to the driver.

In accordance with a preferred embodiment of the present invention, an apparatus is provided. The apparatus comprises means for sensing a phase of a coil current of a brushless direct current (DC) motor; and means for adjusting a phase and frequency of an applied voltage for the brushless DC motor based at least in part on the phase of the coil current to substantially maintain a predetermined phase difference between the phase of the applied voltage and a phase of a back-EMF voltage.

In accordance with a preferred embodiment of the present invention, the apparatus further comprises means for generating a commutation clock signal.

In accordance with a preferred embodiment of the present invention, the apparatus further comprises means for generating the applied voltage to drive the brushless DC motor with commutation clock signal.

In accordance with a preferred embodiment of the present invention, the means for sensing further comprises: means sensing the coil current; means for digitizing the coil current; and means for determining the phase of the coil current from the digitized coil current.

In accordance with a preferred embodiment of the present invention, the means for adjusting further comprises PLL.

In accordance with a preferred embodiment of the present invention, the means for adjusting further comprises: means for calculating an adjustment for the phase and frequency of the applied voltage based at least in part on the digitized coil current; and means for applying the adjustment to the commutation clock signal.

In accordance with a preferred embodiment of the present invention, the means for calculating further comprises a DSP.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a graph depicting the current and voltage waveforms for a conventional controller for a sensorless, brushless DC motor;

FIG. 2 is an example of a system in accordance with a preferred embodiment of the present invention; and

FIGS. 3 and 4 illustrate a example of operation of the system of FIG. 2 for a three-phase DC motor.

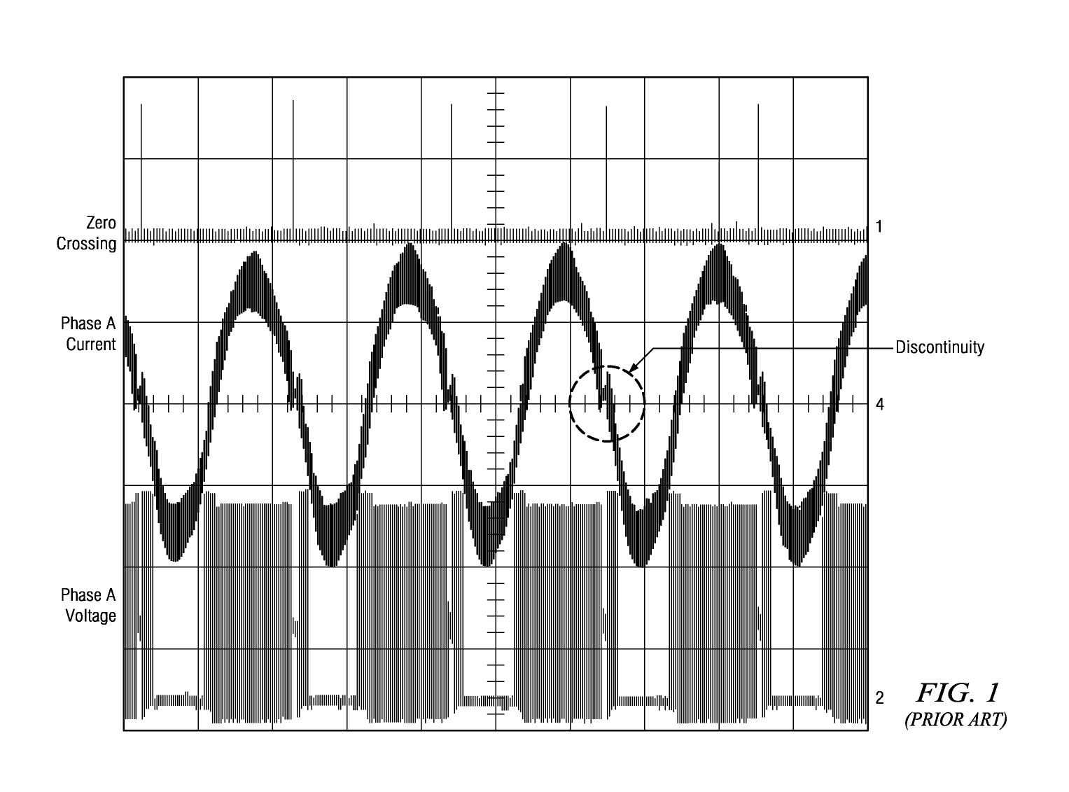

### DETAILED DESCRIPTION

Refer now to the drawings wherein depicted elements are, for the sake of clarity, not necessarily shown to scale and wherein like or similar elements are designated by the same reference numeral through the several views.

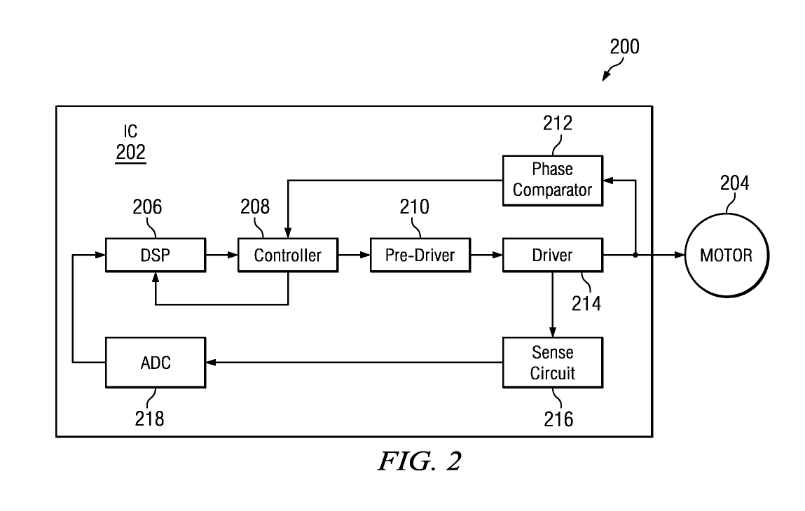

Turning to FIG. 2, a system 200 in accordance with a preferred embodiment of the present invention can be seen. System 200 generally comprises an integrated circuit (IC) 202 and motor 204. The IC 202 generally comprises a digital signals processor (DSP) 206 (which typical includes a memory with a computer program embodied thereon), a controller 208, pre-driver 210, phase comparator 212, driver, 214, sense circuit 216, and an analog-to-digital converter (ADC) 218. In operation, the IC 202 generates an applied voltage and applied (or coil) current for the motor 204 (which can be a sensorless, brushless DC motor with any number of phases) to drive the motor 204. Generally, the applied current or coil current for motor 204 can be expressed as:

$$I ( ω t + {φ}_{3} ) = \frac{{V}_{applied} ( ω t + {φ}_{1} ) - {V}_{EMF} ( ω t + {φ}_{2} )}{{Z}_{MOTOR}} , \qquad ( 12 )$$

where Z_{MOTOR} is the impedance of the motor 204, V_{APPLIED} is the applied voltage, V_{EMF} is the back-EMF voltage, and φ₁, φ₂, and φ₃ is phase information. If equation (12) is adjusted, the back-EMF voltage can be expressed as applied voltage and current as follows:

V_{EMF}(ωt+φ₂)=V_{APPLIED}(ωt+φ₁)−I(ωt+φ₃)·Z_{MOTOR}, (13)

allowing the calculation of a back-EMF voltage from a measured coil current and an applied voltage.

To control the motor 204 without using a back-EMF measurement window when the motor 204 is operating at a generally constant speed, IC 202 calculates the rotational speed and phase information so as to make adjustments accordingly. Since the rotational speed of the motor 204 is generally constant (also known as “run speed” for HDD applications), DSP 204 and controller 208 (which can include a state machine and a phase lock loop or PLL) can easily determine the rotational speed. As the system 200 is operating, the sense circuit 216 (which can include a sense FET) is able to measure the applied or coil current, which can be digitized by the ADC 218. The phase comparator 212 also determines the phase of the applied voltage. The DSP 204 can then calculate the phase of the coil current and calculate an adjustment for the applied voltage based at least in part on the measurements from the phase comparator 212 and sense circuit 216. Preferably, the DSP 204 determines an adjustment for the phase and frequency of the applied voltage so as to substantially maintain a predetermined difference (which can be pre-programmed into the DSP 206) between the phase of the applied voltage and the phase of the back-EMF voltage. This adjustment is applied through commutation clock signal issued by the controller 208. The commutation clock signal can then be converted into the applied voltage (and applied or coil current) for the motor 204 by the pre-driver 210 and driver 214.

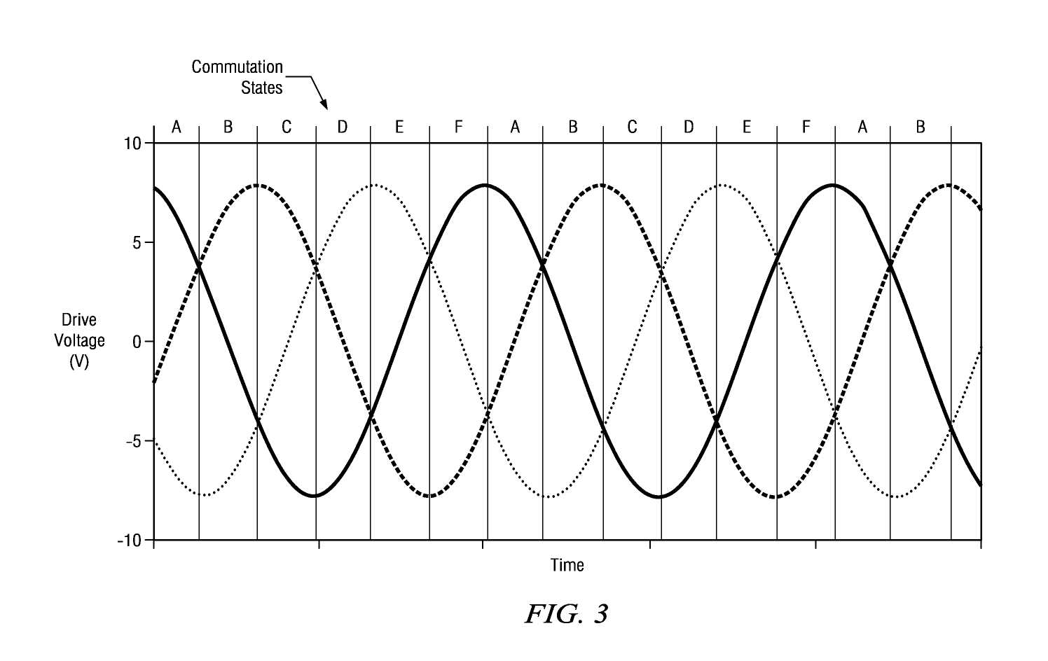

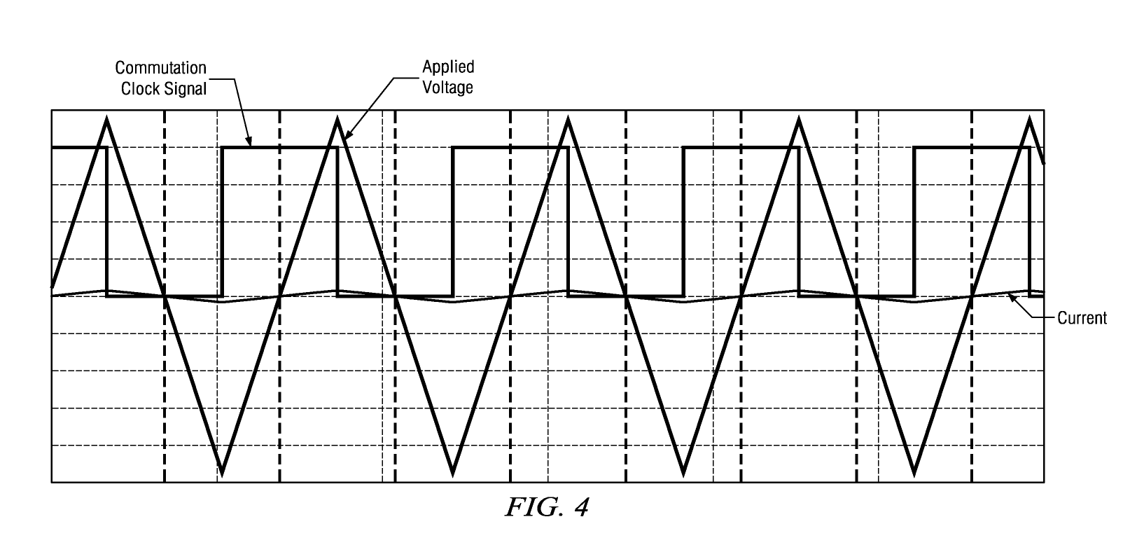

Turning to FIGS. 3 and 4, an example of the operation of the system 200 can be seen. In FIG. 3, applied voltages for three phases (solid line, dashed line, and dotted line) can be seen for the six commutation states (labeled A, B, C, D, E, F). Each of the applied voltages is generally sinusoidal, and for each of the commutation states one of the phases crosses zero. Likewise, the coil current of one of the three phases crosses zero in any given commutation state interval. Because the motor 204 is operating at a generally constant rotational speed (i.e., run speed) and the rotational speed can be easily calculated, the IC 202 can generally ensure that the phase difference between the applied voltage and coil current (as shown in FIG. 4) is generally maintained. In other words, the commutation clock signal (as shown in FIG. 4) is adjusted such that the commutation clock signal is centered at the zero crossings of the applied voltage and coil current.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A method comprising:
sensing a phase of a coil current of a brushless direct current (DC) motor; and
adjusting a phase and frequency of an applied voltage for the brushless DC motor based at least in part on the phase of the coil current to substantially maintain a predetermined phase difference between the phase of the applied voltage and a phase of a back electromotive force (back-EMF) voltage.

2. The method of claim 1, wherein the method further comprises generating a commutation clock signal.

3. The method of claim 2, wherein the method further comprises generating the applied voltage to drive the brushless DC motor with commutation clock signal.

4. The method of claim 3, wherein the step of sensing further comprises:
sensing the coil current;
digitizing the coil current; and
determining the phase of the coil current from the digitized coil current.

5. The method of claim 4, wherein the step of adjusting is performed by a phase lock loop (PLL).

6. The method of claim 5, wherein the step of adjusting further comprises:
calculating an adjustment for the phase and frequency of the applied voltage based at least in part on the digitized coil current with a digital signal processor (DSP); and
applying the adjustment to the commutation clock signal.

7. An apparatus comprising:
a drive circuit that drives a brushless DC motor;
a sense circuit that is coupled to the drive circuit so as to measure a coil current for the brushless DC motor; and
a control circuit that is coupled to the sense circuit and the drive circuit, wherein the control circuit determines a phase of the coil current, and wherein the control circuit adjusts a phase and frequency of an applied voltage for the brushless DC motor to substantially maintain a predetermined phase difference between the phase of the applied voltage and a phase of a back-EMF voltage.

8. The apparatus of claim 7, wherein the sense circuit further comprises a sense FET.

9. The apparatus of claim 8, wherein the control circuit further comprises:
an analog-to-digital converter (ADC) that is coupled to the sense circuit so as to generate a digitized coil current;
a DSP having a memory with a computer program embodied thereon, wherein the DSP is coupled to the ADC, and wherein the DSP calculates an adjustment for the phase and frequency of the applied voltage based at least in part on the digitized coil current; and
a controller that is coupled between the DSP and drive circuit, wherein the controller generates a commutation clock signal for the drive circuit, and wherein the controller applies the adjustment to the commutation clock signal, and wherein the drive circuit generates the applied voltage based at least in part on the commutation clock signal.

10. The apparatus of claim 9, wherein the drive circuit further comprises:
a pre-driver that is coupled to the controller so as to receive the commutation clock signal; and
a driver that is coupled to the pre-driver and the sense circuit.

11. The apparatus of claim 10, wherein the controller further comprises a PLL.

12. The apparatus of claim 11, wherein the apparatus further comprises the DC brushless motor, which is coupled to the driver.

13. An apparatus comprising:
means for sensing a phase of a coil current of a brushless direct current (DC) motor; and
means for adjusting a phase and frequency of an applied voltage for the brushless DC motor based at least in part on the phase of the coil current to substantially maintain a predetermined phase difference between the phase of the applied voltage and a phase of a back-EMF voltage.

14. The apparatus of claim 13, wherein the apparatus further comprises means for generating a commutation clock signal.

15. The apparatus of claim 14, wherein the apparatus further comprises means for generating the applied voltage to drive the brushless DC motor with commutation clock signal.

16. The apparatus of claim 15, wherein the means for sensing further comprises:
means sensing the coil current;
means for digitizing the coil current; and
means for determining the phase of the coil current from the digitized coil current.

17. The apparatus of claim 16, wherein the means for adjusting further comprises PLL.

18. The apparatus of claim 17, wherein the means for adjusting further comprises:
means for calculating an adjustment for the phase and frequency of the applied voltage based at least in part on the digitized coil current; and
means for applying the adjustment to the commutation clock signal.

19. The apparatus of claim 18, wherein the means for calculating further comprises a DSP.
